(19) United States
(12) Patent Application Publication
(10) Pub. No.: US 2013/0089683 A1
(43) Pub. Date: Apr. 11, 2013

(54) FORMULATION OF SURFACE TREATMENT FOR INKJET RECEIVING MEDIA

(71) Applicants: Lyne M. CORMIER, Kirkland (CA); Joseph S. ASPLER, Kirkland (CA); Sylvie ST-AMOUR, Beauharnois (CA); Nam NGUYEN KIM, Brossard (CA)

(72) Inventors: Lyne M. CORMIER, Kirkland (CA); Joseph S. ASPLER, Kirkland (CA); Sylvie ST-AMOUR, Beauharnois (CA); Nam NGUYEN KIM, Brossard (CA)

(73) Assignee: FPINNOVATIONS, Pointe-Claire (CA)

(21) Appl. No.: 13/648,716

(22) Filed: Oct. 10, 2012

Related U.S. Application Data
(60) Provisional application No. 61/545,752, filed on Oct. 11, 2011.

(51) Int. Cl. B41M 5/50; C09D 103/02; C09D 129/04; C08K 3/30

(52) U.S. Cl. 428/32.1; 106/287.17; 106/217.01; 524/47; 524/423

(57) ABSTRACT

A surface coating for paper, the paper produced and method for producing the coated paper as described. The paper is made from at least one of a mechanically, or chemically-derived pulp and the coating includes aluminum sulfate to coagulate the inkjet ink at the paper surface and achieve improved print quality, when compared with coatings without aluminum sulfate.

### CROSS-REFERENCE TO RELATED APPLICATIONS

This application claims the benefit under 35 USC 119(e) of U.S. provisional application Ser. No. 61/545,752, filed Oct. 11, 2011.

### BACKGROUND OF THE INVENTION

i) Field of the Invention

The field of the invention is that of printing papers, in particular those to be printed electronically using inkjet printing technologies.

ii) Description of the Prior Art

Digital print revenue for North America grew at a compound annual rate (CAGR) of 11.1% from 2006 to 2010, despite general print revenue declining at a rate of 0.5% in the same period. Print is projected to grow at 1.3% per annum from 2010 to 2015. Digital's share of print revenue is projected to go from 8.0% in 2006 and 11.3% in 2009 to 18.3% in 2015 (source: Market Intell). The North American print market is about $200 billion (source: Primir). Paper represents up to 40% printers' costs.

The print market shift to digital printing technologies creates a demand for a wider range of papers compatible with these technologies. Currently, there are very few mechanical pulp papers on the market for digital printing.

The majority of inkjet printers designed for home and office use water as the principal solvent system. It was found in very early work that low viscosity water-based inkjet inks applied to paper surfaces may penetrate and spread, greatly reducing visual and measured print quality factors. Undesirable effects of ink penetration and spreading include: reduced optical or print density; poor resolution of features such as printed dots, lines, and characters, and increased print through (the appearance of the image on the reverse side of the print). Other problems that can occur include smearing of the wet ink, and intermixing of two freshly printed wet ink films (“colour to colour bleed”). For this reason, it is necessary to apply special coatings or other treatments to the paper to achieve the highest inkjet print quality.

Conventional office papers are made of chemical pulp. To achieve moderate inkjet quality (e.g., text and simple graphics) on these papers, conventional size press formulations such as starch combined with AKD (alkyl ketene dimer) generally suffice. More specialized materials such as styrene maleic anhydride based sizes may be used as well (e.g. [1]).

A typical specialized inkjet paper coating may contain a hydrophilic polymeric binder such as poly(vinyl alcohol) and a very porous/hydrophilic pigment such as silica. One of the earliest US patents for inkjet printing paper was issued in 1975 [2]. This patent used silica as pigment and gelatine as binder. Many other pigments and binders have also been used or at least suggested for inkjet coatings. These may be applied from an on-machine size press, an on-machine coater, or an off-machine coater. Many hundreds of such patents exist.

### The Use of Alum as a Mordant and as a Coagulant

Aluminum sulfate, Al₂(SO₄)₃ (also known as papermaker's alum, or simply alum) has a long history in the paper and other industries. It should be noted that historically and commercially, the term “alum” may also refer to related compounds such as sodium aluminum sulfate, potassium aluminum sulfate, ammonium aluminum sulfate, and others. Unless otherwise noted, in this document, “alum” refers to an aluminum sulfate Al₂(SO₄)₃, hydroxylated aluminum sulphate and/or polyaluminum sulftate. Alum has at least two key properties relevant to the paper surface.

It is well known that alum acts as a mordant, or an agent to make dyes water-fast on textile fibres. This chemistry has been the subject of many patents in the inkjet field, to counter the poor water-fastness of many dye-based inkjet inks on paper. Typically in these patents, alum (in the form of Al⁺³ ions) or other metal ions are used to fix the ink dyes to the cellulose fibre surface, in the same way that that alum has been used since ancient times to fix dyes to textile fibre surfaces. An example typical of the field is shown in reference [3].

A related property of alum is its ability to form chemical bonds between fatty/resin acid material and the cellulose surface. This is the basis of the rosin-alum sizing process, used in the paper industry for the last 200 years, in which a mixture of alum and resin/fatty acid material is added to the wet end of the paper machine. This is also the basis for the process of “self-sizing”, in which alum added to the paper bonds residual resin/fatty acid “pitch” material from mechanical wood pulps to the fibre surfaces [4]. This is also the basis of the use of alum to coagulate and bind resin and fatty acid “pitch” material within the wet end of the paper machine.

The second key long-known attribute of alum is its ability to coagulate material suspended in water. This attribute of alum is widely used today in water purification; both in treatment of drinking water and in processing of industrial and sewage waste waters.

The ability of alum as a coagulant derives from the trivalent Al⁺³ ion, which will bind and form insoluble precipitates, particularly in the presence of carboxyl (—COON) or carboxylate ions. Indeed, divalent ions such as Ca⁺² also possess this ability, to a lesser extent.

Aqueous aluminum chemistry has been studied for many years, as summarized elsewhere [e.g., 5, 6, 7]. At low pH (less than approximately 4), free aluminum ions (Al⁺³) dominate. At intermediate pH values (from approximately 5 to 8), a complex mixture of aluminum species including insoluble aluminum hydroxide Al(OH)₃ is believed to exist. At higher pH values, the soluble species Al(OH)₄⁻ dominates. Full agreement on the exact composition of such systems does not exist among specialists in the field, due to the complexity of the system and the many aluminum species that can be formed.

Aluminum sulfate is commercially supplied as a dry powder or as an aqueous solution. Related products include poly aluminum sulfate (PAS) and poly aluminum chloride (PAC). PAS may be prepared from alum under controlled conditions of pH and chemical addition. PAC may also be prepared from aluminum chloride or from aluminate sulfate. The flocculation characteristics of PAC and PAS are similar to those of pure aluminum sulfate. Sodium aluminate is also used at higher pH, and when a sulfur-free source of aluminum ions is desired. Today, suppliers now provide pre-hydroxylated aluminum sulfate, a form of alum which has been partially neutralized with caustic.

### The Use of Ca⁺² and Other Metal Ions to Coagulate or Fix Inks

Water-based flexographic printing of newspapers uses styrene-acrylic acid copolymers to stabilize the pigment in the liquid ink, and to bind the pigment to the final print. Research at Paprican (now FPlnnovations) showed that even trace amounts of Al⁺³ extracted from newsprint fibres at acidic pH will cause premature ink coagulation on the printing plate [8, 9], from the interaction between the aluminum ions and the solubilised ink polymers. In a model system, sodium aluminate had a similar effect, with the greatest coagulation effect at alkaline rather than acidic pH [8].

While there was no evidence to show that Ca⁺² extracted from the paper will cause premature ink coagulation on the printing plate, Ca⁺² from excessively hard wash water can indeed cause premature ink coagulation within the inking system [10].

One critical work by Donigian et al. [11] showed that while the silica pigment often used in the highest quality inkjet coatings is effective at absorbing the liquid phase of the ink, calcium carbonate pigments are effective at retaining the dye phase of the ink. The authors claimed that their calcium carbonate surfaces were more effective at “fixing” the inkjet dye, without further describing the mechanism involved.

A patent assigned to Hercules Inc. in 2001 [12] stated that divalent salts including calcium chloride as well as other divalent salts can improve inkjet print quality when added to a size press formulation, in the pH region between 7 and 9. The author claimed that the divalent salt application could be in the very broad range from 0.01 to 1 g/m²; with preferred performance in the range from 0.03 to 0.2 g/m².

A patent application assigned to International Paper [13] claims that small amounts of divalent metal salts added to a conventional size press formulation, particularly CaCl₂, will increase the print density of a pigmented black inkjet ink, while improving edge acuity. Improvements were seen at CaCl₂ coverage as low as 0.2 g/m², although CaCl₂ coverage of 0.5 g/m² was considered to be optimal.

This ability for Ca⁺² to act as a coagulant for inkjet inks was the basis of a patent assigned to Hewlett-Packard Development Co. [14]. The authors stated that metal salts including calcium chloride, magnesium chloride, aluminum chloride, and similar metal salts added to a conventional surface size (e.g., starch or AKD) will immobilize a pigmented or dye-based inkjet ink at the paper surface. According to the claims, between 20 and 25 lb per ton of CaCl₂ or of the other metallic salts gave an increased print density of a pigmented ink, along with faster ink drying time and improved water and light fastness. These were claimed to be effective across a broad pH range, from pH 4 to pH 10.

Ca⁺²-based paper treatments are now being commercialized under the trade names ColorLok® and ColorPro®. One disadvantage of these treatments is that they are not compatible with SBR latex as the latex strongly coagulates in the presence of CaCl₂. Compatibility with latex would open the door to a wide range of coated paper grades.

As already noted, divalent and trivalent cations have been used as mordants for textile colorants for many centuries. These have also been applied as internal additives to uncoated paper, or as additives to size press formulations for uncoated paper. In a patent assigned to Hewlett-Packard Corporation, Zhou [15] described the addition of trivalent aluminum compounds to conventional surface sizing materials such as starch. Similarly, a Korean patent [16] also described a size press formulation containing alum for improving the ink jet performance of uncoated bond papers. In a patent assigned to Georgia Pacific LLC, Bays et al. [17], also described a size press formulations containing alum, the goal of which was to provide good print performance in both inkjet and offset lithographic printing, without interfering with the offset lithographic fountain solution.

In a patent assigned to Newpage Corp., Romano and Justice [18] described an inkjet receptive medium applied as a topcoat to a conventionally coated paper. This receptive medium included divalent or trivalent metal ions, including salts of Zn, Mg, Al, Ca, and Ba.

In patent applications assigned to Appleton Coated LLC, Osterberg and Fenske [19, 20] claimed that divalent or trivalent salts added to paper coatings containing clay and/or calcium carbonate with a binder would act as an inkjet ink fixative.

Although these previous patents [19, 20] claimed coating formulations containing divalent and trivalent metal ions, they neither clearly identified the use of alum in the coating formulations nor showed any specific examples of using alum in coatings. All of the above work targeted chemical pulp based papers.

### SUMMARY OF THE PRESENT INVENTION

The object of this invention is to provide a recording medium or paper for inkjet inks made from both mechanical and chemical pulp, with greater emphasis on mechanical pulp where achieving good inkjet print quality is challenging. Good inkjet printing quality is achieved by adding aluminum-based compounds, particularly aluminum sulfate, to the surface coating or sizing formulations of paper, to coagulate the inkjet ink at the coating surface, thus achieving improved print quality.

The concept builds on the known properties of alum in other fields and applies it for the first time to a coating/sizing formulation to enhance inkjet printing performance of both mechanical and chemical pulp based papers.

In accordance with one aspect of the present invention, there is provided a surface coating formulation for improved inkjet printing quality for paper comprising: an aluminium sulfate, a pigment, and a binder.

In accordance with another aspect of the formulation described herein, the aluminium sulfate is selected from the group consisting of aluminium sulfate, hydroxylated aluminium sulfate, polyaluminum sulfate and combinations thereof.

In accordance with yet another aspect of the formulation described herein, the binder comprises starch or a combination of starch and polyvinyl alcohol.

In accordance with still another aspect of the formulation described herein, the binder further comprises a latex.

In accordance with yet still another aspect of the formulation described herein, the pigment is a calcium carbonate, a clay or combinations thereof.

In accordance with a further aspect of the formulation described herein, the pigment is more than 50% w/w of ground calcium carbonate.

In accordance with yet a further aspect of the formulation described herein, the aluminium sulfate is less than or equal to 20 pph of the formulation.

In accordance with still a further aspect of the formulation described herein, the aluminium sulfate is less than or equal to 10 pph of the formulation.

In accordance with yet still a further aspect of the formulation described herein, the aluminium sulfate is less than or equal to 3.5 pph of the formulation.

In accordance with one embodiment of the formulation described herein, the paper to which it is applied is derived from at least one of a mechanical pulp, a chemical pulp and combinations thereof.

In accordance with another embodiment of the formulation described herein, the paper is derived from mechanical pulps.

In accordance with yet another embodiment of the formulation described herein, the paper is coated.

In accordance with still another embodiment of the formulation described herein, the paper is uncoated.

In accordance with yet still another embodiment of the present invention, there is provided a sizing formulation for improved inkjet printing quality for uncoated paper comprising: an aluminium sulfate, and a binder.

In accordance with a further embodiment of the formulation described herein, the paper is derived from at least one of a mechanical pulp, a chemical pulp and combinations thereof.

In accordance with yet a further embodiment of the formulation described herein, the paper is derived from mechanical pulp.

In accordance with still a further embodiment of the formulation described herein, the aluminium sulfate is selected from the group consisting of aluminium sulfate and hydroxylated aluminium sulfate.

In accordance with yet still a further embodiment of the formulation described herein, further comprising a latex.

In another aspect of the present invention, there is provided a printing paper comprising: a surface coating on at least one side of the base paper, wherein the coating comprises an aluminium sulfate, a pigment, and a binder.

In yet another aspect of the paper described herein, the paper is derived from at least one of a mechanical pulp, a chemical pulp and combinations thereof.

In still another aspect of the paper described herein, the paper is derived from a mechanical pulp.

In yet still another aspect of the paper described herein, the aluminium sulfate is selected from the group consisting of aluminium sulfate, hydroxylated aluminium sulfate, polyaluminum sulfate and combinations thereof.

In a further aspect of the paper described herein, the binder comprises starch or a combination of starch and polyvinyl alcohol.

In yet a further aspect of the paper described herein, the binder further comprising a latex.

In still a further aspect of the paper described herein, the pigments are a calcium carbonate, a clay or combinations thereof.

In yet still a further aspect of the present invention, there is provided a method of producing a coated paper comprising: providing a paper derived from at least one of a mechanical pulp, a chemical pulp and combinations thereof, coating at least one side of the paper with a formulation comprising an aluminium sulfate, a pigment and a binder to produce a coating layer.

In another embodiment of the method described herein, the paper is derived from mechanical pulp.

In yet another embodiment of the method described herein, the aluminium sulfate is selected from the group consisting of aluminium sulfate, hydroxylated aluminium sulfate, polyaluminum sulfate and combinations thereof.

In still another embodiment of the method described herein, the coating binder comprises starch or a combination of starch and polyvinyl alcohol.

In yet still another embodiment of the method described herein, the coating further comprises a latex.

In a further embodiment of the method described herein, the coating pigments are a calcium carbonate, a clay or combinations thereof.

In yet a further embodiment of the method described herein, the aluminium sulfate is less than or equal to 20 pph in the coated layer.

In still a further embodiment of the method described herein, the aluminium sulfate is less than or equal to 10 pph in the coated layer.

In yet still a further embodiment of the method described herein, the aluminium sulfate is less than or equal to 3.5 pph in the coated layer.

### DETAILED DESCRIPTION OF THE INVENTION

The present invention is aimed at producing a multipurpose printing paper that will give good print quality on inkjet printers and presses. Good print quality entails nice colour reproduction, uniformity in the solid areas and good line quality. Associated print quality metrics include colour gamut area, print graininess or mottle, and line raggedness.

The present invention is applicable to paper substrates made of chemical pulp or mechanical pulp or their mixes, virgin or recycled. This invention is of particular interest for the mechanical pulp substrates because existing treatments for inkjet compatibility are mostly for chemical papers, and because mechanical papers have traditionally given very poor inkjet printing performance.

Alum, herein defined as an aluminium sulfate, comprises aluminium sulfate, hydroxylated aluminium sulfate, polyaluminum sulfate and combinations thereof, is understood to act as a coagulant in water-base ink systems. Alum may have other functionalities that help bind the ink to the coating, Contrary to common expectations, alum, despite being a common coagulant for water-based systems, does not coagulate the liquid coating mixture, even in the presence of a latex binder, and allows a uniform coating to be applied to the paper, that is in a preferred embodiment an uncoated paper.

Apart from alum, the coating formulation contains pigments, calcium carbonate (GCC) and/or clay. The largest proportion of pigment can be calcium carbonate or clay depending on the grade of paper. Coating binders used include starch, polyvinyl alcohol (PVOH), and latex. Optical brightening agents (OBA) can be used to enhance paper brightness. Other common coating additives (e.g. crosslinker, lubricant, dyes, etc.) can be present in the formulation. The surface sizing formulation consists of starch with alum. The coating/sizing formulations of this invention can be applied to the paper with existing industrial, pilot or laboratory equipment.

The formulations presented herein, improve printing quality on recording medium, such as printing paper. Improved printing is understood herein to be a comparative improvement of printing quality of the formulation of the present invention compared to the same formulation free of “alum”. The properties of the paper that are improved will be shown in the examples, and include: 6 pt color Gamut Area/Black Optical Density/Graininess Blue Solid/Line Raggedness (mm).

Although the formulation is applicable to various applications, it is particularly directed at printing paper, that is herein defined as a paper suitable for printing, or to be printed on.

The surface treatment formulation of the present invention may be applied on a base paper stock by a surface sizing press such as a puddle-size press, a film-size press or the like.

The coating formulations for the present invention can be applied with conventional coating equipment which include but is not limited to blade coaters, rod coaters, curtain coaters, film presses or size presses.

The base paper may be derived from either a chemical pulp, a mechanical pulp or a combination thereof. Mechanically derived pulps are understood to be treated primarily by mechanically equipment, where heat or chemicals can also be part of the process. Types of mechanical pulps groundwood pulp, refiner mechanical pulp, thermo-mechanical pulp (TMP), and bleached chemi thermo mechanical pulp (BCTMP) Chemically derived pulp is understood to be a pulp that been obtained by dissolving the lignin that holds the wood fibres together. Sulphate and sulphite pulping are the two main chemical pulping processes. Chemical pulps for printing papers are usually bleached to produce white looking papers.

### EXAMPLE 1

### Alum-Containing Coating on Mechanical Pulp Paper

The coating/sizing formulation can be prepared with common equipment used by those familiar with the art. In this example, the starch was batch cooked at 35% solids prior to mixing with PVOH and water for a final coating color concentration of 49% W/W. 90 pph GCC and 10 pph clay pigments, 20 pph starch, 2 ppH PVOH were mixed to form a homogenous suspension. “pph” is a common concentration used in coating formulations. “pph” is defined herein as “parts per hundred grams of dry pigments”. The pH is adjusted with sodium hydroxide prior to the addition of 3pph pre-hydroxylated aluminum sulfate (PAS-8 from Kemira). The optical brightener agent is then added.

The coating color was applied on a mechanical grade paper made from 100% bleached thermo-mechanical pulp (TMP) with a brightness of 80%, with a CLC-6000 coater at a speed of 3000 ft/min. The blade pressure was adjusted in order to get a final coat weight of 4.5 g/m² applied on paper. The samples were IR dried immediately after coating.

The same procedure was used to apply a coating of the same formulation but without alum. Coated samples were printed using a desktop inkjet printer Epson C88+. Visual quality of the samples coated with the alum-containing formulations was better than the sample without alum. Accepted print quality metrics such as colour gamut, optical density, graininess and line raggedness were measured. Adding alum to the coating formulation improved the value of all four solid area quality metrics as can be observed in Table 1. The gains in quality in solid areas did not degrade line quality which was marginally improved or maintained.

TABLE 1
Print quality metrics showing improvement by addition of alum to the coating formulation

| | 6 pt Colour Gamut Area - | Black Optical Density - | Graininess Blue Solid - | Line Raggedness mm - |
|---|---|---|---|---|
| Coating Formulation | Larger is Better | Higher is Better | Lower is Better | Lower is Better |
| Control (No Alum) | 2976 ± 5 | 1.39 ± 0.01 | 3.30 ± 0.03 | 0.011 ± 0.001 |
| 3.5 pph Alum | 3306 ± 9 | 1.42 ± 0.02 | 3.10 ± 0.05 | 0.010 ± 0.001 |

### EXAMPLE 2

### Effect of Alum Level on Inkjet Print Quality

In this example, two different levels (3.5 pph and 10 pph) of alum were added to the same base coating formulation. The coated paper samples were prepared and printed as in example 1. The same coating without alum was used as the control. The results show that print quality is improved further with increased level of alum addition (see Table 2).

TABLE 2
Print Quality Metrics showing further improvement by increased concentration of alum to the coating formulation

| | 6 pt Colour Gamut Area - | Black Optical Density - | Graininess Blue Solid - | Line Raggedness mm - |
|---|---|---|---|---|
| Coating Formulation | Larger is Better | Higher is Better | Lower is Better | Lower is Better |
| Control (No Alum) | 2976 ± 5 | 1.39 ± 0.01 | 3.30 ± 0.03 | 0.011 ± 0.001 |
| 3.5 pph Alum | 3306 ± 9 | 1.42 ± 0.02 | 3.10 ± 0.05 | 0.010 ± 0.001 |
| 10 pph Alum | 3558 ± 13 | 1.39 ± 0.02 | 2.93 ± 0.02 | 0.009 ± 0.000 |

### EXAMPLE 3

### Comparison of Other Alum Types of Salts

In this example we compared two grades of alum (pre-hydroxylated and regular) and sodium aluminate, another aluminium-based coagulant. The same level of addition was used in all formulations. The results show that both alum grades give comparable results with the pre-hydroxylated alum being marginally superior, but that sodium aluminate does not improve print quality when added to the formulation at that concentration.

TABLE 3
Print quality metrics showing comparable performance of regular and pre-
hydroxylated alum and the inferior performance of sodium aluminate

| | 6 pt Colour Gamut Area - | Black Optical Density - | Graininess Blue Solid - | Line Raggedness mm - |
|---|---|---|---|---|
| Coating Formulation | Larger is Better | Higher is Better | Lower is Better | Lower is Better |
| Control (No Alum) | 2976 ± 5 | 1.39 ± 0.01 | 3.30 ± 0.03 | 0.011 ± 0.001 |
| 3.5 pph Hydroxylated | 3306 ± 9 | 1.42 ± 0.02 | 3.10 ± 0.05 | 0.010 ± 0.001 |
| Alum | | | | |
| 3.5 pph Regular Alum | 3261 ± 19 | 1.40 ± 0.02 | 3.18 ± 0.02 | 0.011 ± 0.001 |
| 3.5 pph Sodium | 2895 ± 44 | 1.39 ± 0.01 | 3.59 ± 0.11 | 0.011 ± 0.001 |
| Aluminate | | | | |

### EXAMPLE 4

### Alum in a Latex-Containing Coating Formulation

In this example, alum is used as an additive in a formulation containing 90 pph GCC, 10 pph clay, 9 pph starch, 1 pph PVOH and 8 pph SBR latex. The coating formulation is prepared at 55% solids and applied with the CLC-6000 for a final coat weight of 4.5 g/m². Print testing was performed using an Epson C88+ desktop printer. The gain brought by the addition of alum is in terms of colour gamut and print uniformity (graininess) without degrading the line quality.

TABLE 4
Print quality metrics showing improvement by addition of alum to a coating formulation containing latex

| | 6 pt Colour Gamut Area - | Black Optical Density - | Graininess Blue Solid - | Line Raggedness mm - |
|---|---|---|---|---|
| Coating Formulation | Larger is Better | Higher is Better | Lower is Better | Lower is Better |
| Control (No Alum) | 2898 ± 11 | 1.33 ± 0.03 | 3.37 ± 0.04 | 0.011 ± 0.001 |
| 3.5 pph Hydroxylated | 3209 ± 21 | 1.32 ± 0.02 | 3.18 ± 0.02 | 0.011 ± 0.001 |
| Alum | | | | |
| 10 pph Hydroxylated | 3461 ± 15 | 1.32 ± 0.01 | 2.98 ± 0.06 | 0.010 ± 0.001 |
| Alum | | | | |
| 10 pph Regular Alum | 3350 ± 6 | 1.31 ± 0.01 | 2.85 ± 0.01 | 0.010 ± 0.001 |

### EXAMPLE 5

### Comparison of Coated Paper Prepared in the Laboratory and Paper Coated on Pilot Industrial Equipment

In this example, the same formulation as Example 4 with 10 pph hydroxylated alum was prepared and applied to a paper web at a pilot coater facility. Letter-size paper samples were cut from the paper rolls for the inkjet print quality testing using the Epson C88+. Results show that the samples coated at the pilot facility had the same if not better print quality than the samples produced in the laboratory. This adds to the confidence of the reliability of results obtained on laboratory-produced samples.

TABLE 5
Print quality metrics showing that coated samples produced at the pilot
scale had similar if not better performance than laboratory samples.

| | 6 pt Colour Gamut Area - | Black Optical Density - | Graininess Blue Solid - | Line Raggedness mm - |
|---|---|---|---|---|
| Coating Formulation | Larger is Better | Higher is Better | Lower is Better | Lower is Better |
| Laboratory | 3461 ± 15 | 1.32 ± 0.01 | 2.98 ± 0.06 | 0.010 ± 0.001 |
| Pilot scale | 3541 ± 10 | 1.34 ± 0.01 | 3.11 ± 0.01 | 0.009 ± 0.002 |

### EXAMPLE 6

### Use of Alum in Starch Surface Sizing (By Weight % of the Surface Sizing Composition)

In this example, alum is incorporated in at different concentrations in a starch suspension before being applied on paper with the CLC-6000 for a final dry weight of 1.5 g/m2. The substrate was a mechanical paper with no internal sizing. Samples were IR-dried immediately after sizing. Samples were soft-nip calendered to the same PPS-S10 roughness prior to print testing. Table 4 shows that the print properties of the sized paper containing alum are improved compared to the sized paper without alum.

TABLE 6
Data showing improved colour gamut area when
alum is mixed with starch for surface sizing

| Starch Sizing | 6 pt Colour Gamut Area - |
|---|---|
| Formulation | Larger is Better |
| Control (Starch Only) | 2455 ± 19 |
| 2% Hydroxylated Alum | 2550 ± 11 |
| 5% Hydroxylated Alum | 2676 ± 19 |
| 10% Hydroxylated Alum | 2823 ± 11 |
| 15% Hydroxylated Alum | 2947 ± 1 |
| 30% Hydroxylated Alum | 3081 ± 29 |

### EXAMPLE 7

### Performance on Different Types of Paper Substrates

In this example, the same coating formulations and coat weight were applied on either a mechanical paper sheet or commercial copy paper (chemical paper), and tested following the same methodology as in previous examples. Print quality results show that the improvement in print quality occurs whether the paper substrate is made from mechanical or chemical pulp.

TABLE 7
Print quality data obtained for mechanical and chemical paper substrates

| | Coating | 6 pt Colour Gamut Area - | Graininess Blue Solid - | Line Raggedness mm - |
|---|---|---|---|---|
| Paper Type | Formulation | Larger is Better | Lower is Better | Lower is Better |
| Mechanical paper | Uncoated paper | 2782 ± 11 | 2.69 ± 0.01 | 0.013 ± 0.001 |
| | 10 pph Hydroxylated | 3558 ± 13 | 2.93 ± 0.02 | 0.009 ± 0.000 |
| | Alum | | | |
| | 10 pph Regular Alum | 3332 ± 45 | 2.92 ± 0.05 | 0.010 ± 0.001 |
| | 10 pph Hydroxylated | 3461 ± 15 | 2.98 ± 0.06 | 0.010 ± 0.001 |
| | Alum + latex | | | |
| Chemical paper | Uncoated paper | 2930 ± 74 | 3.00 ± 0.10 | 0.012 ± 0.001 |
| | 10 pph Hydroxylated | 3685 | 2.46 | 0.009 ± 0.001 |
| | Alum | | | |
| | 10 pph Regular Alum | 3689 | 2.62 | 0.008 ± 0.001 |
| | 10 pph Hydroxylated | 3694 | 2.68 | 0.008 ± 0.001 |
| | Alum + latex | | | |

### EXAMPLE 8

### Formulation with only Clay as the Pigment

In this example, a coating formulation containing 100 pph clay, 30 pph starch, 2.5 pph PVOH and 10 pph hydroxylated alum was prepared and applied to a mechanical paper web at a pilot coater facility. For this example, the control sample is the paper without coating. As this type of paper is intended mostly for text reproduction, only the relevant print quality metrics were compared. The results show that the text reproduction quality improves with the application of a coating to the paper.

TABLE 8
Print quality metrics related to text print quality

| | Black Optical Density - | Line Raggedness mm - |
|---|---|---|
| Sample | Higher is Better | Lower is Better |
| Uncoated | 1.17 ± 0.01 | 0.013 ± 0.001 |
| Clay-based coating | 1.40 ± 0.01 | 0.010 ± 0.001 |

### REFERENCES

1. Batten, G. L., Jr., Effects of SMA [Styrene-Maleic Anhydride] Surface Sizes on Paper End-Use Properties, 1994 Tappi Papermakers Conference Proceedings, Book 2, 413-418, Tappi Press, Atlanta.
2. Hoffman, K., Konig, H -D., Meyer, K., Ink jet recording material, U.S. Pat. No. 3,889,270, Jun. 10, 1975, assigned to Agfa-Gevaert A G.
3. Akutsu, E., Fujii, T., Murakami, K., Aruga, T., Recording Medium for Ink-Jet Printing, U.S. Pat. No. 4,740,420, Apr. 26, 1988. Assigned to Ricoh Co. Ltd.
4. Aspler, J. S., Chauret, N., and Lyne, M. B.; The Mechanism of Self-Sizing, in “Papermaking Raw Materials”, Proceedings of the Eighth Fundamental Research Symposium, Oxford, Mechanical Engineering Publications Ltd., London V. 2, 707 - 727 (1985).
5. Hem., J. D., Chemistry of aluminum in natural water, US Geological Survey Water Supply Paper 1827-B, US Government Printing Office, Washington, 1968.
6. Horoszko, W. L. and Smylie, S. E., Aluminum Compounds—Chemistry and Use, Chapter 9 in J. Gess, Ed., Retention of Fines and Fillers During Papermaking, Tappi Press, Atlanta, 1998.
7. Martin, R. G., The chemistry of aluminum as related to biology and medicine, Clinical Chemistry 32:1797 (1986).
8. Aspler, J. S. and Perreault, Z. F.; Newsprint Requirements for Water-based Flexography, Part II: Newsprint Chemistry and Water-based Inks, J. Pulp and Paper Sci., 14 (1), J12 - J16 (1988).
9. Aspler, J. S.; The Contribution of Newsprint to Fill-in of Flexographic Printing Plates, J. Pulp and Paper Science, 18, J99 - J103, (1992).
10. MacAdam, R. and Mueller, R., How the Miami Herald overcame problems in newsflexo printing, Flexo 14:6, 30 (1989).
11. Donigian, D. W., Wernett, P. C., McFadden, M. G., and McKay, J. J., Ink-jet dye fixation and coating pigments, Tappi Journal 82(8):175 (1999).
12. Varnell, D., Composition and method for improved ink jet printing performance, U.S. Pat. No. 6,207,258, Mar. 17, 2001; Assigned to Hercules Inc.
13. Koenig, M., et al., Recording sheet with improved image dry time, US Patent Application 2007/0087138 A1, Apr. 19, 2007; Assigned to International Paper Co.
14. J. L. Stoffel et al., Composition and ink receiving system incorporating the composition, U.S. Pat. No. 7,582,188, Sep. 1, 2009; Assigned to Hewlett-Packard Development Co.
15. Zhou, X., Surface treatment composition, inkjet printable article, and method of making the same, World International Property Organization Application WO2009/157952, Dec. 30, 2009, Assigned to Hewlett-Packard Development Co.
16. Bae, J. Y., Bang, Y. P., Koo, S. H., and Yoon, S. H., Production of multipurpose paper for ink jet printing, Korean Patent KR2001047268, Jun. 15, 2001, Assigned to Kyesung Paper Co. Ltd.
17. Bays, L. A., Kokko, B. J., Schmelzer, M. A., and Schroder, G. L., Dual-mode ink jet paper, US Patent Application 2009/0017235, Jan. 15, 2009, Assigned to Georgia Pacific LLC.
18. Romano, C. F. and Justice, R. G., Inkjet recording medium, US Patent Application 2011/0050827, Mar. 3, 2011, Assigned to Newpage Corp.
19. Osterberg, D. L. and Fenske, B. J., Coated paper for inkjet printing and method for inkjet printing, European Patent Application 2289705, Mar. 2, 2011 Assigned to Appleton Coated LLC.
20. Osterberg, D. L. and Fenske, B. J., Coated paper for inkjet printing and method for inkjet printing, US Patent Application 2011/0052818, Mar. 3, 2011 Assigned to Appleton Coated LLC.

1. A surface coating formulation for improved inkjet printing quality for paper comprising:
an aluminium sulfate,
a pigment, and
a binder.

2. The formulation according to claim 1, wherein the aluminium sulfate is selected from the group consisting of aluminium sulfate, hydroxylated aluminium sulfate, polyaluminum sulfate and combinations thereof.

3. The formulation according to claim 1, wherein the binder comprises starch or a combination of starch and polyvinyl alcohol.

4. The formulation according to claim 1, wherein the binder further comprising a latex.

5. The formulation according to claim 1, wherein the pigment is a calcium carbonate, a clay or combinations thereof.

6. The formulation of claim 5, wherein the pigment is more than 50% w/w of ground calcium carbonate.

7. The formulation according to claim 6, wherein the aluminium sulfate is less than or equal to 10 pph of the formulation.

8. The formulation according to claim 6, wherein the aluminium sulfate is less than or equal to 3.5 pph of the formulation.

9. The formulation according to claim 1, wherein the paper to which it is applied is derived from at least one of a mechanical pulp, a chemical pulp and combinations thereof.

10. A sizing formulation for improved inkjet printing quality for uncoated paper comprising:
an aluminium sulfate, and
a binder.

11. The formulation according to claim 10, wherein the paper is derived from at least one of a mechanical pulp, a chemical pulp and combinations thereof.

12. The formulation according to claim 11, wherein the paper is derived from mechanical pulp.

13. The formulation according to claim 11, wherein the aluminium sulfate is selected from the group consisting of aluminium sulfate and hydroxylated aluminium sulfate.

14. The formulation according to claim 11, further comprising a latex.

15. A printing paper comprising:
a surface coating on at least one side of the base paper, wherein the coating comprises
an aluminium sulfate,
a pigment, and
a binder.

16. The paper according to claim 15, wherein the paper is derived from at least one of a mechanical pulp, a chemical pulp and combinations thereof.

17. The paper according to claim 16, wherein the paper is derived from a mechanical pulp.

18. The paper according to claim 15, wherein the aluminium sulfate is selected from the group consisting of aluminium sulfate, hydroxylated aluminium sulfate, polyaluminum sulfate and combinations thereof.

19. The paper according to claim 15, wherein the binder comprises starch or a combination of starch and polyvinyl alcohol.

20. The paper according to claim 15, wherein the binder further comprising a latex.

21. The paper according to claim 15, wherein the pigments are a calcium carbonate, a clay or combinations thereof.
